(19) United States
(12) Patent Application Publication
(10) Pub. No.: US 2016/0305651 A1
(43) Pub. Date: Oct. 20, 2016

(54) CERAMIC COATING AND PROCESS FOR APPLYING THE SAME

(71) Applicant: Fireside Coatings, Inc., Orange Park, FL (US)

(72) Inventor: Edward J. Lloyd, Orange Park, FL (US)

(21) Appl. No.: 14/690,636

(22) Filed: Apr. 20, 2015

(51) Int. Cl. F22B 37/06; B05D 7/00

(52) U.S. Cl. CPC F22B 37/06; B05D 7/52

(57) ABSTRACT

A dual color sprayed on composite ceramic coating configured and formulated to protect fireside boiler tubing while also acting as a visual inspection aid. The coating is an environmentally safe, non-reactive, water soluble composite ceramic that will withstand operating temperatures up to 2000° F. (1093° C.). This coating is ideal for fluidized bed boilers and coal fired utility boilers experiencing tube erosion, corrosion and slagging. This sprayed-on ceramic coating system allows for fast application rates reducing equipment down time. The composite ceramic coating is a high solids system that will withstand severe thermal cycling from −300° F. (−185° C.) to 1600° F. (871° C.). This composite system is applied in two distinct colors to enable easy visual inspection of coating thickness.

### BACKGROUND OF THE INVENTION

1. Field of the Invention

This invention relates to a ceramic coating composition for use in boilers, furnaces, and the like, particularly for use on boiler tubes, and to a method for coating boiler tubes and other surfaces exposed to high temperatures to extend the service life and increase the thermal conductivity thereof, the coating being characterized by resistance to heat, erosion, corrosion, slagging, and fouling.

2. Description of Related Art

Boiler tubes generally have a relatively short life due to corrosion and erosion problems which exist in high temperature boilers. The high boiler temperatures together with the flow of hot gases carrying particles, soot and other wear and erosion-causing materials generally result in aggravated wear through the tube walls. Complete tube stacks or panels have been known to require replacement in a matter of months.

In order to avoid or postpone the need to replace boiler tubes and other components exposed to the high temperature environment of a boiler, these components are often coated with a protective coating. The protective coatings used vary, but they all must periodically be reapplied once the coating has corroded and/or eroded to an unsafe condition. The only way to determine the remaining coating thickness is to shut down the boiler, then construct scaffolding and measure the remaining coating with a magnetic lift off device, which is costly and time consuming especially if all surfaces are measured and evaluated to determine high erosive and/or corrosive areas. Alternately the conditions in the boiler could cause slag and fouling materials to deposit on the coating, which decease the thermal efficiency of the boiler and should be removed to restore and maintain boiler performance. During removal of these deposits, the protective coating may be thinned or damaged. Accordingly, the thickness of the protective coating should be checked and measured to determine if the protective coating should be reapplied. During scheduled shut down periods identification of tube wear is of great concern to boiler operators.

An object of this invention is to avoid and overcome the defects and deficiencies of the prior art practices by providing a ceramic composition and method for coating surfaces, such as boiler tubes, to extend the useful life and/or extend the service intervals thereof. Another object is to develop a ceramic coating system, which provides for a quicker and less expensive method of inspecting the thickness of the protective ceramic coating in a boiler. Other objects of the invention will clearly appear when taken in conjunction with the following disclosure and the accompanying drawings.

### SUMMARY OF THE INVENTION

The present invention is directed to, in general, a dual color, sprayed-on ceramic coating composition and system that when applied to properly prepared fireside boiler tubing will not only reduce corrosion and erosion, caused from burning corrosive or erosive fuels, but will allow for a visual inspection of the remaining ceramic coating thickness.

In several embodiments, the invention is a dual color sprayed on composite ceramic coating configured and formulated to protect fireside boiler tubing while also acting as a visual inspection aid. The coating is an environmentally safe, non-reactive, water soluble composite ceramic that will withstand operating temperatures up to 2000° F. (1093° C.). This coating is ideal for fluidized bed boilers and coal fired utility boilers experiencing tube erosion, corrosion and slagging. This sprayed-on ceramic coating system allows for fast application rates reducing equipment down time. The composite ceramic coating is a high solids system that will withstand severe thermal cycling from −300° F. (−185° C.) to 1600° F. (871° C.). This composite system is applied in two distinct colors. The base (white) coat is formulated to provide high mechanical bonding and is erosion and corrosion resistant. The base coat can be applied at least up to 0.008 thick (203 microns). The top (green) coat can be applied at least up to 0.012 thick (304 microns). This allows for thicker applications to applied in areas of higher wear such as roof tubes, refractory interface areas and corners.

The top coat forms a strong chemical bond to the base coat, has exceptional erosion and corrosion resistance and high emissivity and is thermally conductive. After a significant period of operation, the dual color ceramic coating will allow operators and inspectors to visually see any areas of erosion or corrosion. These areas will begin to show the white base coat. Wear areas can then be addressed before tube thinning or failure occurs. Coating thickness can be easily evaluated using a simple magnetic lift off device. Due to the coatings' high bonding characteristics, if required, it can be brush blasted and re-applied to specification very quickly with limited down time and without removal of any existing ceramic coating.

In one embodiment, the coating is applied in two colors. The base layer is applied at a minimum thickness of 0.006 thick and is white. The top coat can be applied at least up to 0.012 thick and is green. After each layer is applied, the coating is measured with a magnetic lift off device and the thickness of both the white layer and the green layer are recorded separately. As the top (green) layer wears away (due to corrosion or erosion) the bottom (white) layer will be exposed. This composite coating can then be visually inspected with a hand held light from a distance. If the white base layer has not been exposed, then there is no need to address the coating thickness until the next scheduled boiler outage.

In another embodiment, the invention is a method of forming a composite ceramic coating for high temperature environments, including the steps of providing a first ceramic composition comprising: sodium silicate, potassium silicate, zirconium dioxide, and aluminum oxide; providing a second ceramic composition comprising: sodium silicate, potassium silicate, zirconium dioxide, and aluminum oxide, applying the first ceramic composition to a substrate, creating a first ceramic coating having a first color, applying the second ceramic composition to the first ceramic coating of the first color, creating a second ceramic coating having a second color, wherein the first color and the second color are visually distinct from each other. In yet another embodiment, the first ceramic composition further comprises dolomite. In still another embodiment, the second ceramic composition further comprises silicon carbide. In another embodiment, the second ceramic composition further comprises chromium(III) oxide. In another embodiment, the first ceramic composition further comprises dolomite, and the second ceramic composition further comprises silicon carbide and chromium(III) oxide. In yet another embodiment, the first ceramic composition is applied to the substrate as a water based composition. In another embodiment, the second ceramic composition is applied to the substrate as a water based composition. In still another embodiment, the first ceramic composition is applied to the substrate as a water based composition, and wherein the second ceramic composition is applied to the substrate as a water based composition. In yet another embodiment, the dolomite in the first ceramic composition comprises 1-5% by weight of the total solids in the first ceramic composition.

In another embodiment, the invention is a composite ceramic coating including, a first ceramic coating having a first color, the first ceramic coating comprising: sodium silicate, potassium silicate, zirconium dioxide, and aluminum oxide, a second ceramic coating having a second color, the second ceramic coating comprising: sodium silicate, potassium silicate, zirconium dioxide, and aluminum oxide, wherein the first ceramic coating is adhered to a substrate, wherein the second ceramic coating is adhered to the first ceramic coating, and wherein the first color and the second color are visually distinct from each other. In another embodiment, the first ceramic coating further comprises dolomite. In yet another embodiment, the second ceramic coating further comprises silicon carbide. In still another embodiment, the second ceramic coating further comprises chromium(III) oxide. In another embodiment, the first ceramic coating further comprises dolomite, and the second ceramic composition further comprises silicon carbide and chromium(III) oxide. In yet another embodiment, the first ceramic coating is applied to the substrate as a water based composition. In another embodiment, the second ceramic coating is applied to the substrate as a water based composition. In another embodiment, the first ceramic coating is applied to the substrate as a water based composition, and wherein the second ceramic coating is applied to the substrate as a water based composition. In another embodiment, the first ceramic coating comprises 1-5% dolomite by weight. In another embodiment, the first ceramic coating comprises 2-4% dolomite by weight. In another embodiment, the first ceramic coating comprises about 3% dolomite by weight.

These and other features and characteristics of the present invention will become more apparent upon consideration of the following description and the appended claim with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a side view of a boiler tube coated with a composite ceramic coating of an embodiment of the present invention;

FIG. 2 shows a cross-sectional view taken along lines II-II of a boiler tube coated with a composite ceramic coating, shown in FIG. 1, of an embodiment of the present invention;

FIG. 3 is a side view of a boiler tube with its surface being prepared for application of a ceramic coating according to an embodiment of the invention;

FIG. 4 is a side view of a boiler tube having a first ceramic coating sprayed onto its outer surface according to an embodiment of the invention;

FIG. 5 is a side view of a boiler tube having a second ceramic coating sprayed onto the first ceramic coating disposed on its outer surface according to an embodiment of the invention;

FIG. 6 is a side view of a boiler tube coated with a composite ceramic coating of an embodiment of the present invention;

FIG. 7 is a side view of a boiler tube coated with a composite ceramic coating where a portion of the second ceramic coating has been lost, making the first ceramic coating visible to the naked eye of an embodiment of the present invention; and

FIG. 8 shows a cross-sectional view taken along lines III-III of a boiler tube coated with a composite ceramic coating where a portion of the second ceramic coating has been lost, making the first ceramic coating visible to the naked eye, shown in FIG. 7, of an embodiment of the present invention.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawings. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

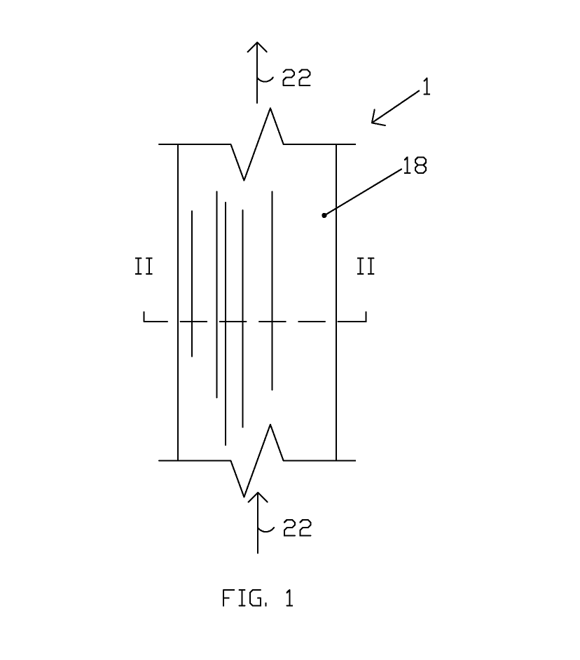

Referring generally to FIGS. 1-8, the present invention is directed to, in general, a dual color sprayed-on ceramic coating that when applied to properly prepared fireside boiler tubing will not only reduce corrosion and erosion caused from burning corrosive or erosive fuels, but will allow for a visual inspection of the remaining ceramic coating thickness, and a method of applying the same.

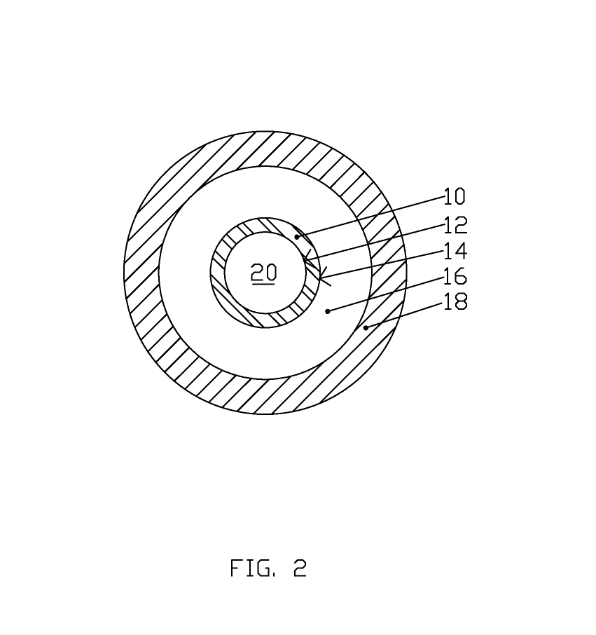

FIGS. 1 and 2 show an embodiment of the present invention applied to a boiler tube generally designated 1. The coated boiler tube 1 includes metal boiler tube 10 having an inner surface 12 and an outer surface 14. The outer surface 14 is coated with a first ceramic coating 16 which is coated with a second ceramic coating 18. The metal boiler tube 10 defines a passageway 20 which is configured to communicate water and/or steam along the direction indicated by directional arrows 22. The visual inspection aid feature of the present invention is enabled by the first ceramic coating 16 being visually distinct from second the ceramic coating 18. The first ceramic coating 16 and/or the second ceramic coating 18 can be colored by including pigments in their formulations. One suitable pigment for this application is Chromium(III) oxide green, which is chemically very stable and contrasts with the residues found in boilers, however those skilled in the art will recognize that other pigments may be used. (e.g. cadmium pigments, cobalt pigments, titanium pigments, carbon black, ultramarine pigment, and the like.)

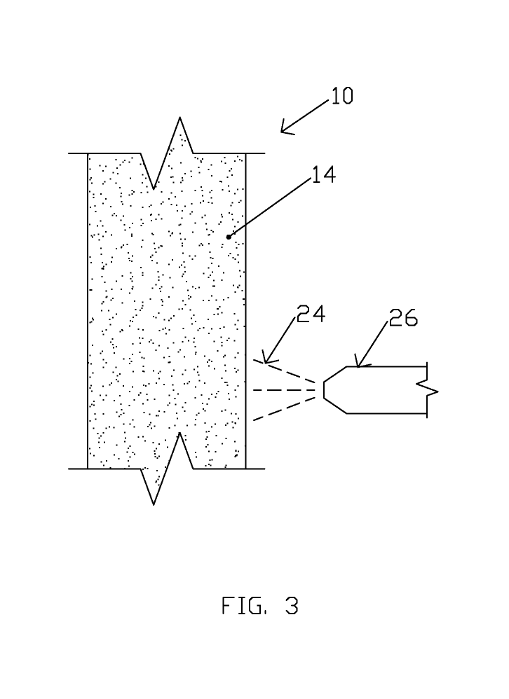

Referring more particularly to FIGS. 3-6, where a method of forming a composite ceramic coating on a metal boiler tube 10 according to an embodiment of the present invention is illustrated. Referring specifically to FIG. 3, the metal boiler tube 10 should be thoroughly cleaned and prepared prior to application of a ceramic coating. All Chlorides, grease, oil, cutting compounds, UT coupling and oil based contaminants should be removed from the outer surface 14 of the metal boiler tube 10 by solvent cleaning. Optionally for large surface areas, the metal boiler tube 10 can be cleaned with an alkaline detergent or non-petroleum solvent, followed by a steam or fresh water wash to remove detrimental residue. Next, the outer surface 14 of the metal boiler tube 10 is blasted with sharp blast abrasive 24 via an abrasive blast nozzle 26 to achieve a NACE 1, SSPC-SPS white blast specification and a 0.003 anchor tooth profile. It is preferred to use only dry filtered compressed air in the abrasive blasting process. To achieve proper production rates, compressed air volume and pressure should be scaled properly for the abrasive blasting equipment being used.

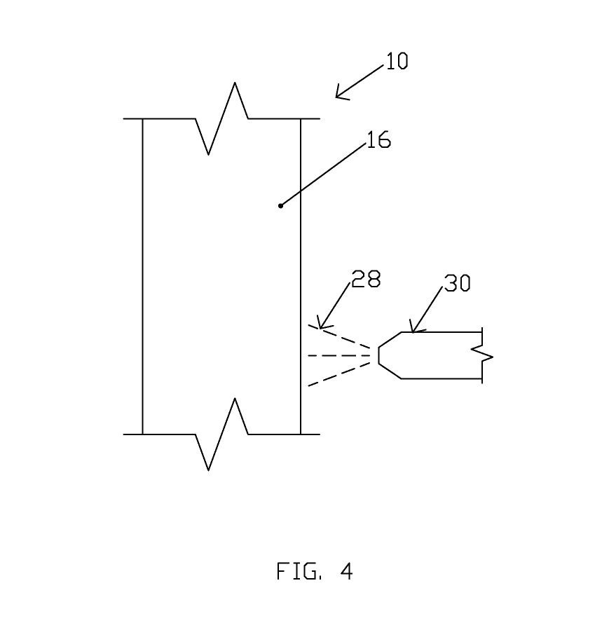

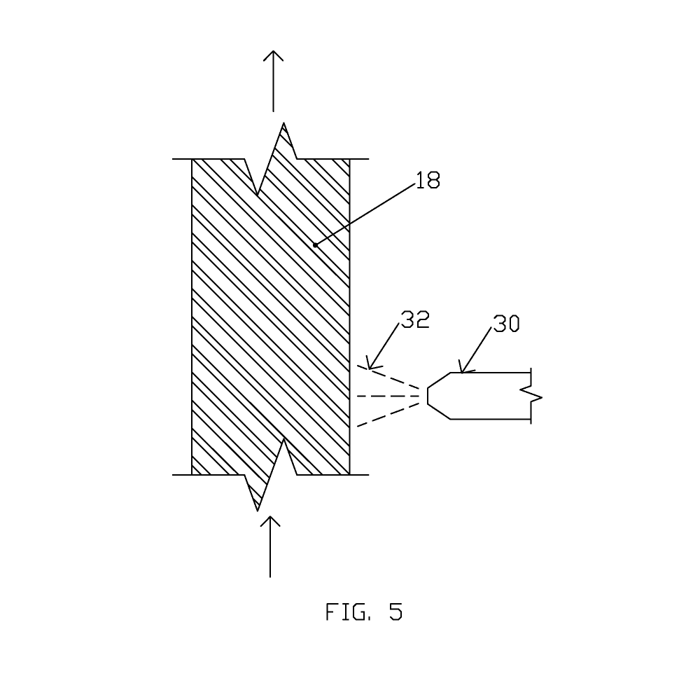

Referring more particularly to FIGS. 4 and 5, which show a first ceramic composition 28 being sprayed onto metal boiler tube 10 via a spray nozzle 30 to form the first ceramic coating 16, and a second ceramic composition 32 being sprayed onto the first ceramic coating 16 on the metal boiler tube 10 via a spray nozzle 30 to form the second ceramic coating 18, respectively. During these application steps, the temperature of outer surface 14 should be a minimum of 5° F. (3° C.) above the dew point and above 50° F. (10° C.). When applying the first ceramic composition 28, it is recommended to not exceed a maximum dry film thickness of 0.008 (203 microns). It is recommended for best results to apply the first ceramic composition 28 in subsequent coats of approximately 0.002 (51 microns) thick. Each coat should be allowed to completely dry to the touch (est. 1 hour) before adding additional coats. Coating thickness should be checked after each coat to assure proper thickness building is being achieved during application. Standard minimum recommended thickness for the first ceramic coating 16 is 0.005-0.006 (127-152 micron) after completing the first ceramic coating 16, measurement and inspection should be conducted to ensure the proper coating thickness has been achieved. Additional coats are added as required to achieve the proper thickness specification for the first ceramic coating 16. Next, the second ceramic composition 32 is applied in subsequent coats via spray nozzle 30 to form the second ceramic coating 18. Similarly to the steps above, each coat should be completely dry before adding additional coats. The recommended thickness for the second ceramic coating 18 is 0.012 (305 microns). The first ceramic coating 16 and the second ceramic coating 18 should not be exposed to water or moisture before they are cured. Until fired, the first ceramic coating 16 and the second ceramic coating 18 are uncured even when dry to the touch and may wash off with water until the curing procedure is completed.

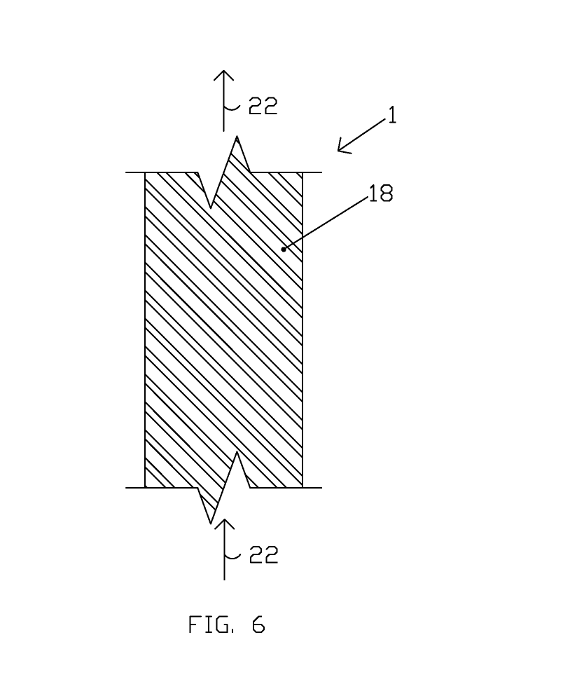

Referring more particularly to FIG. 6, to begin the curing process the first ceramic coating 16 and the second ceramic coating 18 are allowed to dry in ambient air above 50° F. (10° C.) for at least sixteen hours. Then the first ceramic coating 16 and the second ceramic coating 18 are subjected to a temperature of about 180° F. (88° C.) for two hours. Then, the temperature is raised to about 300° F. (149° C.) for one hour. Finally, the first ceramic coating 16 and the second ceramic coating 18 are heated to about 450° F. (232° C.) for one hour. Once these steps are completed the coated boiler tube 1 is ready for service.

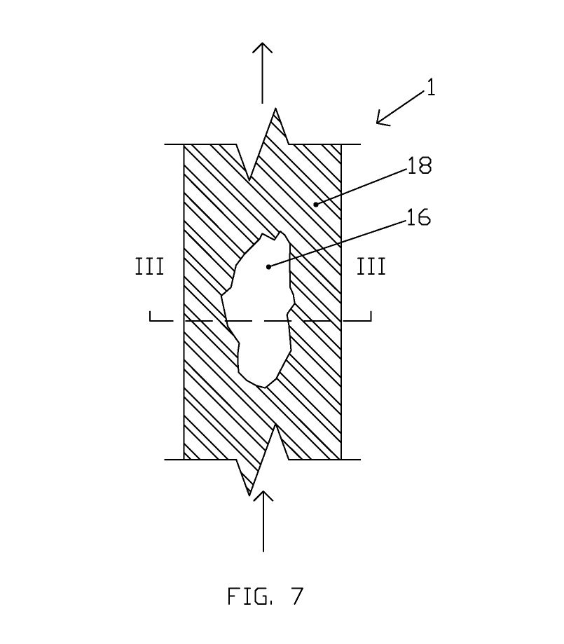

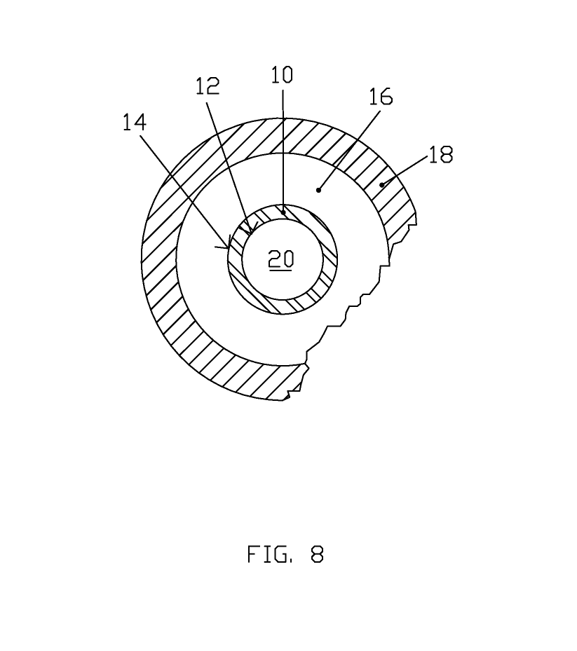

Referring more particularly to FIGS. 7 and 8, as the second ceramic coating 18 wears away due to corrosion or erosion the first ceramic coating 16 will be exposed. This composite coating can then be visually inspected with a hand held light from a distance and if the white first ceramic coating 16 has not been exposed there is no need to address the coating thickness until the next scheduled boiler outage.

The charts below show several exemplary coating composition formulations according to the present invention.

### Example 1

| GREEN SECOND | WHITE FIRST |
|---|---|
| CERAMIC COMPOSITION | CERAMIC COMPOSITION |
| CERAMIC - (DILUTED | CERAMIC - (DILUTED |
| WITH WATER TO | WITH WATER TO |
| MAKE 5 GAL.) | MAKE 5 GAL.) |
| 16 lb sodium silicate and | 20 lb sodium silicate and |
| silica crystalline | silica crystalline |
| 9 lb monoclinic zirconium | 10 lb monoclinic zirconium dioxide |
| 1 lb aluminum oxide | 5 lb aluminum oxide |
| 40 lb-50 lb potassium silicate | 40 lb-50 lb potassium silicate |
| 1 lb Silicon carbide | |
| 3.5 lb Chromium Oxide green | |

### Example 2

| GREEN SECOND | WHITE FIRST |
|---|---|
| CERAMIC COMPOSITION | CERAMIC COMPOSITION |
| CERAMIC - (DILUTED | CERAMIC - (DILUTED |
| WITH WATER TO | WITH WATER TO |
| MAKE 5 GAL.) | MAKE 5 GAL.) |
| 16 lb sodium silicate and | 20 lb sodium silicate and |
| silica crystalline | silica crystalline |
| 9 lb monoclinic zirconium | 10 lb monoclinic zirconium dioxide |
| 1 lb aluminum oxide | 5 lb aluminum oxide |
| <40 lb potassium silicate | <40 lb potassium silicate |
| 1 lb Silicon carbide | |
| 3.5 lb Chromium Oxide green | |

### Example 3

| GREEN SECOND | WHITE FIRST |
|---|---|
| CERAMIC COMPOSITION | CERAMIC COMPOSITION |
| CERAMIC - (DILUTED | CERAMIC - (DILUTED |
| WITH WATER TO | WITH WATER TO |
| MAKE 5 GAL.) | MAKE 5 GAL.) |
| 16 lb sodium silicate and | 20 lb sodium silicate and |
| silica crystalline | silica crystalline |
| 9 lb monoclinic zirconium | 4 lb monoclinic zirconium dioxide |
| 1 lb aluminum oxide | 4 lb aluminum oxide |
| 40 lb-50 lb potassium silicate | 2 lb dolomite |
| 1 lb Silicon carbide | 40-50 lb potassium silicate |
| 3.5 lb Chromium Oxide green | |

### Example 4

| GREEN SECOND | WHITE FIRST |
|---|---|
| CERAMIC COMPOSITION | CERAMIC COMPOSITION |
| CERAMIC - (DILUTED | CERAMIC - (DILUTED |
| WITH WATER TO | WITH WATER TO |
| MAKE 5 GAL.) | MAKE 5 GAL.) |
| 16 lb sodium silicate and | 20 lb sodium silicate and |
| silica crystalline | silica crystalline |
| 9 lb monoclinic zirconium | 4 lb monoclinic zirconium dioxide |
| 1 lb aluminum oxide | 4 lb aluminum oxide |
| <40 lb potassium silicate | 2 lb dolomite |
| 1 lb Silicon carbide | <40 lb potassium silicate |
| 3.5 lb Chromium Oxide green | |

While various embodiments of the present invention were provided in the foregoing description, those skilled in the art may make modifications and alterations to these embodiments without departing from the scope and spirit of the invention. For example, it is to be understood that this disclosure contemplates that, to the extent possible, one or more features of any embodiment can be combined with one or more features of any other embodiment. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A method of forming a composite ceramic coating for high temperature environments, comprising the steps of:
a. providing a first ceramic composition comprising: sodium silicate, potassium silicate, zirconium dioxide, and aluminum oxide,
b. providing a second ceramic composition comprising: sodium silicate, potassium silicate, zirconium dioxide, and aluminum oxide,
c. applying the first ceramic composition to a substrate, creating a first ceramic coating having a first color,
d. applying the second ceramic composition to the first ceramic coating of the first color, creating a second ceramic coating having a second color,
wherein the first color and the second color are visually distinct from each other.

2. The method of claim 1, wherein the first ceramic composition further comprises dolomite.

3. The method of claim 1, wherein the second ceramic composition further comprises silicon carbide.

4. The method of claim 1, wherein the second ceramic composition further comprises chromium(III) oxide.

5. The method of claim 1, wherein the first ceramic composition further comprises dolomite, and the second ceramic composition further comprises silicon carbide and chromium(III) oxide.

6. The method of claim 1, wherein the first ceramic composition is applied to the substrate as a water based composition.

7. The method of claim 1, wherein the second ceramic composition is applied to the substrate as a water based composition.

8. The method of claim 1, wherein the first ceramic composition is applied to the substrate as a water based composition, and wherein the second ceramic composition is applied to the substrate as a water based composition.

9. The method of claim 1, wherein the dolomite in the first ceramic composition comprises 1-5% by weight of the total solids in the first ceramic composition.

10. A composite ceramic coating comprising:
a first ceramic coating having a first color, the first ceramic coating comprising: sodium silicate, potassium silicate, zirconium dioxide, and aluminum oxide,
a second ceramic coating having a second color, the second ceramic coating comprising: sodium silicate, potassium silicate, zirconium dioxide, and aluminum oxide,
wherein the first ceramic coating is adhered to a substrate,
wherein the second ceramic coating is adhered to the first ceramic coating, and
wherein the first color and the second color are visually distinct from each other.

11. The composite ceramic coating of claim 10, wherein the first ceramic coating further comprises dolomite.

12. The composite ceramic coating of claim 10, wherein the second ceramic coating further comprises silicon carbide.

13. The composite ceramic coating of claim 10, wherein the second ceramic coating further comprises chromium(III) oxide.

14. The composite ceramic coating of claim 10, wherein the first ceramic coating further comprises dolomite, and the second ceramic composition further comprises silicon carbide and chromium(III) oxide.

15. The composite ceramic coating of claim 10, wherein the first ceramic coating is applied to the substrate as a water based composition.

16. The composite ceramic coating method of claim 10, wherein the second ceramic coating is applied to the substrate as a water based composition.

17. The composite ceramic coating of claim 10, wherein the first ceramic coating is applied to the substrate as a water based composition, and wherein the second ceramic coating is applied to the substrate as a water based composition.

18. The composite ceramic coating of claim 10, wherein the first ceramic coating comprises 1-5% dolomite by weight.

19. The composite ceramic coating of claim 10, wherein the first ceramic coating comprises 2-4% dolomite by weight.

20. The composite ceramic coating of claim 10, wherein the first ceramic coating comprises about 3% dolomite by weight.
